(19) United States
(12) Patent Application Publication
(10) Pub. No.: US 2025/0233667 A1
(43) Pub. Date: Jul. 17, 2025

(54) COMMUNICATION APPARATUS AND OPTICAL PATH OPENING METHOD

(71) Applicant: NIPPON TELEGRAPH AND TELEPHONE CORPORATION, Tokyo (JP)

(72) Inventors: Shin KANEKO, Musashino-shi (JP); Takuya KANAI, Musashino-shi (JP); Naotaka SHIBATA, Musashino-shi (JP); Junichi KANI, Musashino-shi (JP)

(73) Assignee: NIPPON TELEGRAPH AND TELEPHONE CORPORATION, Tokyo (JP)

(21) Appl. No.: 18/854,128

(22) PCT Filed: Apr. 15, 2022
(86) PCT No.: PCT/JP2022/017894

§ 371 Date: Oct. 4, 2024

(51) Int. Cl. H04B 10/40; H04J 14/02

(52) U.S. Cl. CPC H04B 10/40; H04J 14/0213; H04J 14/0234

(57) ABSTRACT

A communication device is a first communication device in an optical communication system including the first communication device, a second communication device, and a control device that controls opening of an optical path between the first communication device and the second communication device, and the communication device includes a first reception unit configured to receive a downlink control signal that is an optical signal having a predetermined wavelength transmitted from the control device; and a second reception unit configured to receive a main signal that is an optical signal having a wavelength different from the predetermined wavelength transmitted from the second communication device.

### TECHNICAL FIELD

The present invention relates to a communication apparatus and an optical path opening method.

### BACKGROUND ART

To realize a new network infrastructure that enables high speed and large capacity, drastic reduction in delay, and reduction in power consumption, which cannot be realized in current networks, research on an all photonics network (APN) based on photonics technology has been in progress (see, for example, Non Patent Literature 1). The APN can reduce delay to the utmost by providing an end-to-end and full-mesh optical path connection utilizing a wavelength, and can flexibly provide a high-speed and large-capacity wavelength-dedicated network by function.

In the APN, in a case where a new subscriber device is connected to a network, a subscriber device management control unit in an APN controller recognizes that the subscriber device has been connected, and dispenses a wavelength from unused wavelengths and instructs the subscriber device to set the wavelength. At the same time, an optical distribution control unit in the APN controller selects an optimum optical path according to a communication partner of the subscriber device, and sets the optical path by an optical distribution means in a photonic gateway (Ph-GW). In this way, automatic opening of the end-to-end optical path is realized.

As described above, in an existing optical communication system, the optical distribution control unit sets inter-port connection by the optical distribution means so that the subscriber device at the time of initial connection can communicate with the subscriber device management control unit. As soon as registration, authentication, wavelength setting, and the like of the subscriber device are completed, the optical distribution control unit changes the inter-port connection by the optical distribution means, and opens the optical path directly connected to the subscriber device as the communication partner. However, in a configuration of the existing optical communication system, after the optical path is once opened, the communication path between the subscriber device and the subscriber device management control unit is cut off. Therefore, there is no control channel for transmitting a control signal from the control unit to the subscriber device as they are.

Therefore, a method is conceivable in which an optical multiplexing/demultiplexing means is provided on an optical fiber transmission line and an optical signal carrying a main signal and an optical signal carrying a control signal are multiplex or demultiplexed, and a management control port for communication with the subscriber device after optical path opening is provided in the subscriber device management control unit. Then, by connecting the management control port for communication with the subscriber device after the optical path opening and the optical multiplexing/demultiplexing means, an optical communication system can transmit an uplink control signal from the subscriber device to the subscriber device management control unit and a downlink control signal from the subscriber device management control unit to the subscriber device even after the optical path opening.

### CITATION LIST

### Non Patent Literature

Non Patent Literature 1: Takuya Kanai, Kazuaki Honda, Yasunari Tanaka, Shin Kaneko, Kazuki Hara, Junichi Kani, and Tomoaki Yoshida, “All-Photonics Network wo sasaeru Photonic Gateway (in Japanese) (Photonic Gateway Supporting All-Photonics Network)” The Institute of Electronics, Information and Communication Engineers General Conference, B-8-20, March 2021.

### SUMMARY OF INVENTION

### Technical Problem

However, before the optical path opening, if the wavelength of the downlink control signal transmitted from the management control port for communication with the subscriber device before the optical path opening is not within a transmission wavelength band of a wavelength filter provided in the subscriber device, the subscriber device cannot receive the downlink control signal. Note that the wavelength filter is installed in a preceding stage of a receiver for receiving a control signal. Similarly, after the optical path opening, if the wavelength of the downlink control signal transmitted from the management control port for communication with the subscriber device after the optical path opening is not within the transmission wavelength band of the wavelength filter provided in the subscriber device, the subscriber device cannot receive the downlink control signal.

As described above, conventionally, there is a problem that the subscriber device cannot receive the downlink control signal unless the wavelength of the downlink control signal falls within a range of the transmission wavelength band of the wavelength filter provided in the subscriber device before and after the optical path opening.

The present invention has been made in view of the above-described technical background, and an object of the present invention is to provide a technology that enables a subscriber device to receive a downlink control signal transmitted from a subscriber device management control unit before and after optical path opening, and can open an optical path between the subscriber devices.

### Solution to Problem

The first aspect of the present invention is a communication device that is a first communication device in an optical communication system including the first communication device, a second communication device, and a control device that controls opening of an optical path between the first communication device and the second communication device, the communication device including: a first reception unit configured to receive a downlink control signal that is an optical signal having a predetermined wavelength transmitted from the control device; and a second reception unit configured to receive a main signal that is an optical signal having a wavelength different from the predetermined wavelength transmitted from the second communication device.

One aspect of the present invention is an optical path opening method in an optical communication system including a first communication device, a second communication device, and a control device that controls opening of an optical path between the first communication device and the second communication device, the optical path opening method including: a first control signal transmission step of transmitting, by the control device, a downlink control signal to the first communication device at a predetermined wavelength through a first communication port before opening of the optical path; a second control signal transmission step of transmitting, by the control device, the downlink control signal to the first communication device at a predetermined wavelength through a second port connected to an optical multiplexing means that multiplexes a main signal and the downlink control signal, after the opening of the optical path; a first reception step of receiving, by the first communication device, the downlink control signal by a first reception means capable of receiving an optical signal of the predetermined wavelength; and a second reception step of receiving, by the first communication device, the main signal by a second reception means capable of receiving an optical signal of a wavelength different from the predetermined wavelength.

### Advantageous Effects of Invention

According to the present invention, before and after the optical path opening, the subscriber device can receive the downlink control signal transmitted from the subscriber device management control unit, and the optical path between the subscriber devices can be opened.

### BRIEF DESCRIPTION OF DRAWINGS

FIG. 1 is a diagram for describing an optical path opening method in an existing optical communication system 1.

FIG. 2 is an overall configuration diagram of an existing optical communication system 1′.

FIG. 3 is a diagram for describing an optical path opening method in an optical communication system 1a according to a first embodiment of the present invention.

FIG. 4 is a flowchart illustrating an operation of the optical communication system 1a according to the first embodiment of the present invention.

FIG. 5 is an overall configuration diagram of an optical communication system 1b according to a modification 1 of the first embodiment of the present invention.

FIG. 6 is an overall configuration diagram of an optical communication system 1c according to a modification 2 of the first embodiment of the present invention.

FIG. 7 is an overall configuration diagram of an optical communication system 1d according to a modification 3 of the first embodiment of the present invention.

FIG. 8 is a diagram for describing an optical path opening method in an optical communication system 1e according to a second embodiment of the present invention.

FIG. 9 is a flowchart illustrating an operation of the optical communication system 1e according to the second embodiment of the present invention.

FIG. 10 is an overall configuration diagram of an optical communication system if according to a modification of the second embodiment of the present invention.

### DESCRIPTION OF EMBODIMENTS

Hereinafter, a communication device and an optical path opening method according to an embodiment will be described with reference to the drawings.

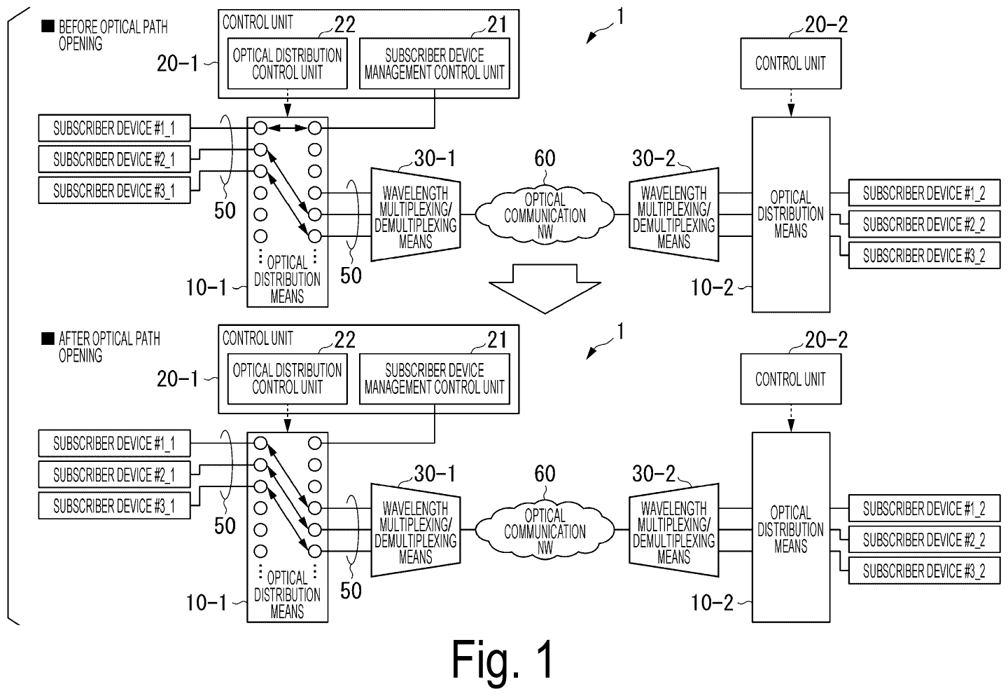

Hereinafter, to make the description easy to understand, first, a configuration of an optical communication system 1 that is an example of an existing optical communication system will be described. FIG. 1 is a diagram for describing an optical path opening method in an existing optical communication system 1.

As illustrated in FIG. 1, the existing optical communication system 1 includes a plurality of subscriber devices #k_1 (k=1, 2, . . . ), a plurality of subscriber devices #k_2 (k=1, 2, . . . ), an optical distribution means 10-1 and an optical distribution means 10-2, a control unit 20-1 and a control unit 20-2, a wavelength multiplexing/demultiplexing means 30-1 and a wavelength multiplexing/demultiplexing means 30-2, a plurality of optical fiber transmission lines 50, and an optical communication network (NW) 60. The optical distribution means 10-1 and the optical distribution means 10-2 are configured using, for example, an optical switch or the like.

Hereinafter, as an example, an optical path opening method in a case where the subscriber device #k_1 is newly connected to the network and communicably connected to the subscriber device #k_2 as a communication partner via the optical fiber transmission line 50, the optical distribution means 10-1, and the like will be described. Note that, on the contrary, an optical path opening method in a case where the subscriber device #k_2 is newly connected to the network and is connected to the subscriber device #k_1 as the communication partner via the optical fiber transmission line 50, the optical distribution means 10-2, and the like is similar to the configuration to be described below.

The optical distribution means 10-1 includes a plurality of ports. The optical distribution means 10-1 is connected to the plurality of optical fiber transmission lines 50. The optical distribution means 10-1 outputs an optical signal input through each port to a port for which a connection relationship is set as a connection port for each port. Note that the connection relationship between the plurality of ports can be arbitrarily changed and set.

The subscriber device #k_1 is connected to the optical distribution means 10-1 via the optical fiber transmission line 50. As illustrated in the upper diagram of FIG. 1, at the time of initial connection of the subscriber device #k_1 to the network, an optical distribution control unit 22 changes a setting of inter-port connection by the optical distribution means 10-1 in order to enable communication between the subscriber device #k_1 and a subscriber device management control unit 21.

At the time of initial connection of the subscriber device #k ito the network, management control information necessary for registration and authentication of the subscriber device #k_1 to the network is exchanged between the subscriber device #k_1 and the subscriber device management control unit 21. In addition, at the time of initial connection of the subscriber device #k_1 to the network, the management control information for instructing a light emission wavelength to be used by the subscriber device #k_1 is transmitted from the subscriber device management control unit 21 to the subscriber device #k_1. As a channel for transmitting and receiving such management control information, for example, an auxiliary management and control channel (AMCC) or the like can be used.

Next, as illustrated in the lower diagram of FIG. 1, as soon as the registration, authentication, wavelength setting, and the like of the subscriber device #k_1 to the network are completed, the optical distribution control unit 22 changes the setting of the inter-port connection by the optical distribution means 10-1 again in order to transfer the optical signal transmitted from the subscriber device #k_1 to the subscriber device #k_2 to be the communication partner. As a result, the optical communication system 1 can open an optical path directly connecting the subscriber device #k_1 and the subscriber device #k_2.

However, in such a configuration of the existing optical communication system 1, since the communication path between the subscriber device #k_1 and the subscriber device management control unit 21 is cut off after the optical path is once opened, there is no control channel for transmitting a downlink control signal transmitted from the subscriber device management control unit 21 to the subscriber device #k_1 or transmitting an uplink control signal transmitted from the subscriber device #k_1 to the subscriber device management control unit 21 as they are, as illustrated in the lower diagram of FIG. 1. In this case, the subscriber device management control unit 21 cannot monitor a state of the optical path and a state of the subscriber device #k_1 or perform optical path switching control.

Therefore, a method is conceivable in which an optical multiplexing/demultiplexing means 70 is provided on the optical fiber transmission line 50 and an optical signal carrying a main signal and an optical signal carrying a control signal are multiplexed or demultiplexed, and a management control port for communication with the subscriber device #k_1 after optical path opening is provided in the subscriber device management control unit 21. Then, by connecting the management control port for communication with the subscriber device #k_1 after the optical path opening and the optical multiplexing/demultiplexing means 70, the optical communication system 1 can transmit the uplink control signal from the subscriber device #k_1 to the subscriber device management control unit 21 and the downlink control signal from the subscriber device management control unit 21 to the subscriber device #k_1 not only before the optical path opening but also after the optical path opening.

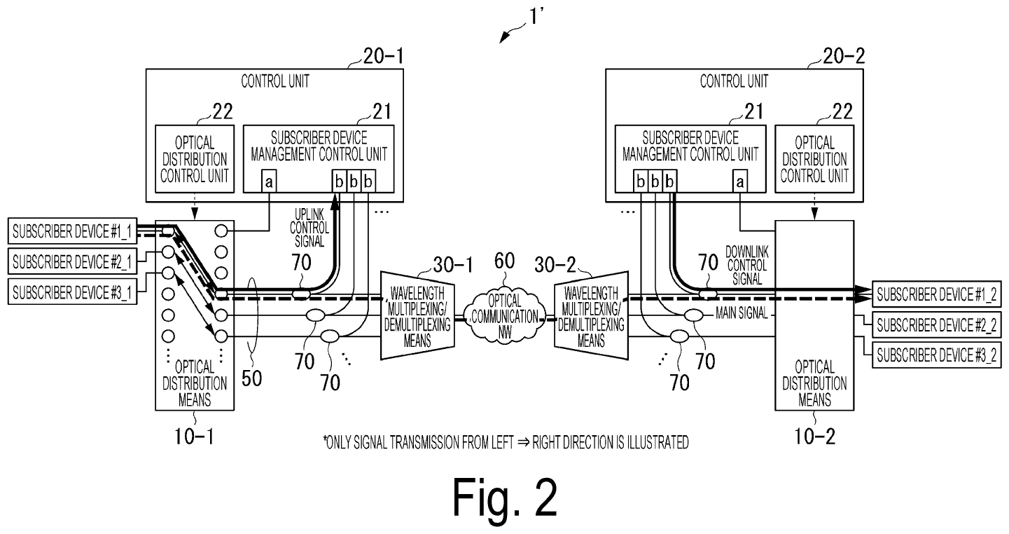

Hereinafter, an overall configuration of an optical communication system 1′ that is an example of an existing optical communication system will be described. FIG. 2 is an overall configuration diagram of the existing optical communication system 1′. As illustrated in FIG. 2, the existing optical communication system 1′ includes a plurality of subscriber devices #k_1 (k=1, 2, . . . ), a plurality of subscriber devices #k_2 (k=1, 2, . . . ), an optical distribution means 10-1 and an optical distribution means 10-2, a control unit 20-1 and a control unit 20-2, a wavelength multiplexing/demultiplexing means 30-1 and a wavelength multiplexing/demultiplexing means 30-2, a plurality of optical fiber transmission lines 50, an optical communication network (NW) 60, and a plurality of optical multiplexing/demultiplexing means 70.

Note that, in the following description, among components included in the existing optical communication system 1′ illustrated in FIG. 2, components having configurations similar to those included in the existing optical communication system 1 illustrated in FIG. 1 are denoted by the same reference numerals, and description thereof is omitted.

As illustrated in FIG. 2, the optical multiplexing/demultiplexing means 70 is provided in each of the plurality of optical fiber transmission lines 50. The optical multiplexing/demultiplexing means 70 is configured using, for example, an optical demultiplexer/multiplexer or the like. The subscriber device management control unit 21 is provided with a management control port a that is a management control port for communication with the subscriber device #k_1 before the optical path opening and a management control port b that is a management control port for communication with the subscriber device #k_1 after the optical path opening. Since the optical multiplexing/demultiplexing means 70 and the management control port b are connected, the existing optical communication system 1′ can mutually transmit the uplink control signal from the subscriber device #k_1 to the subscriber device management control unit 21 and the downlink control signal from the subscriber device management control unit 21 to the subscriber device #k_1 even after the optical path opening.

The existing optical communication system 1′ illustrated in FIG. 2 performs control such that the wavelength of the optical signal carrying the downlink control signal and the wavelength of the optical signal carrying the main signal are different from each other. As a result, the existing optical communication system 1′ can avoid interference between the main signal and the downlink control signal at the time of reception even in a case where a frequency band of the downlink control signal and a frequency band of the main signal overlap with each other. Specifically, in the existing optical communication system 1′, the subscriber device #k_1 separates the downlink control signal and the main signal having wavelengths different from each other, and detects and demodulates the downlink control signal and the main signal. Accordingly, the subscriber device #k_1 can receive both the downlink control signal and the main signal.

Before and after the optical path opening, the subscriber device management control unit 21 transmits the downlink control signals addressed to the same subscriber device #k_1 through different management control ports. Specifically, for example, as illustrated in FIG. 1, the subscriber device management control unit 21 transmits the downlink control signal addressed to the subscriber device #k_1 through the management control port a before the optical path opening, and transmits the downlink control signal addressed to the subscriber device #k_1 through the management control port b after the optical path opening.

The subscriber device #k_1 includes a wavelength filter (not illustrated), and has reception wavelength selectivity capable of selecting a specific wavelength and receiving an optical signal. However, before the optical path opening, the subscriber device #k_1 cannot receive the downlink control signal unless the wavelength of the downlink control signal transmitted through the management control port a for communication with the subscriber device #k_1 before the optical path opening falls within the range of the transmission wavelength band of the wavelength filter (not illustrated) installed in the preceding stage of the receiver for the downlink control signal in the subscriber device #k_1.

Further, similarly, after the optical path opening, the subscriber device #k_1 cannot receive the downlink control signal unless the wavelength of the downlink control signal transmitted through the management control port b for communication with the subscriber device #k_1 after the optical path opening falls within the range of the transmission wavelength band of the wavelength filter installed in the preceding stage of the receiver for the downlink control signal in the subscriber device #k_1. An optical communication system according to an embodiment of the present invention that can solve such a problem will be described below.

### First Embodiment

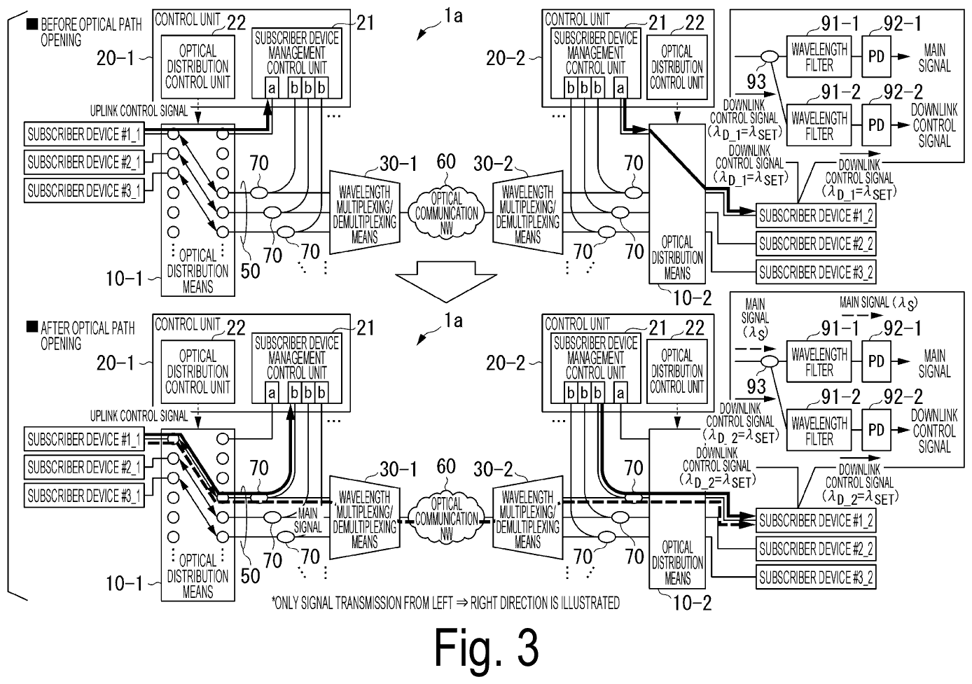

Hereinafter, an optical communication system 1a according to a first embodiment will be described. FIG. 3 is a diagram for describing an optical path opening method in the optical communication system 1a according to the first embodiment of the present invention.

As illustrated in FIG. 3, the optical communication system 1a in the first embodiment includes a plurality of subscriber devices #k_1 (k=1, 2, . . . ), a plurality of subscriber devices #k_2 (k=1, 2, . . . ), an optical distribution means 10-1 and an optical distribution means 10-2, a control unit 20-1 and a control unit 20-2, a wavelength multiplexing/demultiplexing means 30-1 and a wavelength multiplexing/demultiplexing means 30-2, a plurality of optical fiber transmission lines 50, an optical communication network (NW) 60, and a plurality of optical multiplexing/demultiplexing means 70. Note that, in the following description, among components included in the optical communication system 1a according to the first embodiment illustrated in FIG. 3, the components having similar configurations to the components included in the conventional optical communication system 1 illustrated in FIG. 1 and the components included in the existing optical communication system 1′ illustrated in FIG. 2 are denoted by the same reference numerals, and description thereof is omitted.

A wavelength λ_{D_1} of a downlink control signal transmitted through a management control port a for communication with the subscriber device #k_2 before optical path opening is determined to λ_{SET} in advance. Here, λ_{SET} is a wavelength different from a wavelength that can be allocated to a main signal after the optical path opening. Further, in the first embodiment, λ_{SET} is the same wavelength as a wavelength allocated to a downlink control signal after the optical path opening.

For example, a wavelength fixed transmitter whose emission wavelength is λ_{SET} is used as a transmitter (not illustrated) included in a subscriber device management control unit 21 that transmits the downlink control signal through the management control port a. Alternatively, for example, a wavelength tunable transmitter is used as a transmitter (not illustrated) provided in the subscriber device management control unit 21 that transmits the downlink control signal through the management control port a. In the case where the wavelength tunable transmitter is used, the subscriber device management control unit 21 sets the emission wavelength of the wavelength tunable transmitter that transmits the downlink control signal through the management control port a to λ_{SET}.

Note that, in the optical communication system 1a, the wavelength λ_{D_1} of the downlink control signal does not need to be set to a different wavelength for each subscriber device #k_2 (k=1, 2, . . . ). That is, the wavelength λ_{D_1} of the downlink control signal transmitted through the management control port a for communication with the subscriber device #k_2 before the optical path opening may be configured to be fixed to λ_{SET} in the case of all the subscriber devices #k_2.

The subscriber device #k_2 sets a receiver (not illustrated) for downlink control signal reception to selectively receive the optical signal having the wavelength λ_{SET}. As illustrated in FIG. 3, the subscriber device k_2 includes a wavelength filter 91-1 in a preceding stage of a receiver (not illustrated) for main signal reception, and a wavelength filter 91-2 in a preceding stage of the receiver for downlink control signal reception. As illustrated in FIG. 3, optical signals demultiplexed by an optical demultiplexing means 93 are input to the wavelength filter 91-1 and the wavelength filter 91-2, respectively. Then, as illustrated in FIG. 3, the subscriber device k_2 is configured to perform direct detection using, for example, a photodiode (PD) 92-1 and a photodiode (PD) 92-2 as photoelectric conversion means.

In the above configuration, for example, a wavelength fixed filter having a wavelength transmission characteristic that transmits the signal of the wavelength λ_{SET} is used as the wavelength filter 91-2 provided in the preceding stage of the receiver for downlink control signal reception. Alternatively, for example, a wavelength tunable filter is used as the wavelength filter 91-2 provided in the preceding stage of the receiver for downlink control signal reception. In the case where the wavelength tunable filter is used, the subscriber device #k_2 sets the wavelength tunable filter (the wavelength filter 91-2) to transmit the optical signal of the wavelength λ_{SET}.

Note that, in the case where the wavelength tunable filter is used as the wavelength filter 91-2, the subscriber device #k_2 may be configured to be set in advance such that the wavelength tunable filter transmits the signal of the wavelength λ_{SET} before the optical path opening. Alternatively, in the case where the wavelength tunable filter is used as the wavelength filter 91-2, the subscriber device #k_2 may be configured to detect that the wavelength of the downlink control signal is the wavelength λ_{SET} before the optical path opening by sweeping the transmission band of the wavelength tunable filter.

Note that, in a case where coherent reception is applied to the reception of the downlink control signal, the subscriber device #k_2 does not need to include the wavelength filter 91-1 and the wavelength filter 91-2. In this case, the subscriber device #k_2 sets the wavelength of local light to be in a vicinity of the wavelength λ_{SET}, and selectively demodulates the optical signal of the downlink control signal and a beat component of the local light.

In addition, the wavelength λ_{D_2} of the downlink control signal transmitted through the management control port b for communication with the subscriber device #k_2 after the optical path opening is also determined to be the wavelength λ_{SET} in advance, similarly to the wavelength λ_{D_1} of the downlink control signal transmitted through the management control port a described above. Therefore, for example, a wavelength fixed transmitter whose emission wavelength is λ_{SET} can be used as a transmitter (not illustrated) that transmits the downlink control signal through the management control port b.

Alternatively, for example, a wavelength tunable transmitter is used as the transmitter (not illustrated) that transmits the downlink control signal through the management control port b. In the case where the wavelength tunable transmitter is used, the subscriber device management control unit 21 sets the emission wavelength of the wavelength tunable transmitter that transmits the downlink control signal through the management control port b to λ_{SET}.

Note that an optical distribution means different from the optical distribution means 10-2 may be arranged between the management control port b of the subscriber device management control unit 21 and the optical multiplexing/demultiplexing means 70, and an output of the management control port b may be distributed to the optical multiplexing/demultiplexing means 70 according to a destination of the downlink control signal. In this case, the number of management control ports b can be reduced.

Note that, in a case where the wavelength filter 91-2 provided in the preceding stage of the receiver (not illustrated) for downlink control signal reception in the subscriber device #k_2 has wavelength tunability, the subscriber device #k_2 may maintain the setting of the transmission wavelength of the wavelength filter 91-2 so as to continuously transmit the signal of the wavelength λ_{SET} even after the optical path opening.

Note that, in a case where coherent reception is applied to the reception of the downlink control signal, the subscriber device #k_2 may continue to maintain the setting so that the wavelength of the local light is in the vicinity of the wavelength λ_{SET}, and selectively demodulate the optical signal of the downlink control signal and the beat component of the local light.

Meanwhile, the subscriber device #k_1 (k=1, 2, 3, . . . ) transmits the uplink control signal to be transmitted to the subscriber device management control unit 21 at a wavelength different from the wavelength of the main signal. Alternatively, the subscriber device #k_1 (k=1, 2, 3, . . . ) may transmit the uplink control signal to be transmitted to the subscriber device management control unit 21 by multiplexing the frequency of the uplink control signal on the same wavelength as the main signal.

Note that, in the case where the uplink control signal is transmitted at a wavelength different from the wavelength of the main signal (the former case), the subscriber device #k_1 may transmit the uplink control signal at the wavelength λ_{XD_2} in a configuration in which light having a wavelength different from the wavelength of the main signal transmitted from the subscriber device #k_1 does not reach the subscriber device #k_2 that is the communication partner.

For example, as illustrated in FIG. 3, in a case where the wavelength multiplexing/demultiplexing means 30-1 is inserted into the optical fiber transmission line 50, an optical signal of a wavelength different from the wavelength of the main signal transmitted from the subscriber device #k_1 cannot pass through the wavelength multiplexing/demultiplexing means 30-1 and does not reach the subscriber device #k_2 as the communication partner. Therefore, since the optical signal of the uplink control signal is not input to the subscriber device #k_2 of the communication partner, even if the wavelength of the optical signal of the uplink control signal is the same wavelength λ_{D_2} as the wavelength of the optical signal of the downlink control signal, the subscriber device #k_2 of the communication partner can receive the downlink control signal without having the downlink control signal interfere with other signals.

Note that, in the configuration of the optical communication system 1a according to the first embodiment illustrated in FIG. 3, the optical multiplexing/demultiplexing means 70 is disposed between the optical distribution means 10-1 and the wavelength multiplexing/demultiplexing means 30-1 and between the optical distribution means 10-2 and the wavelength multiplexing/demultiplexing means 30-2, but the embodiment is not limited to such a configuration. For example, the optical multiplexing/demultiplexing means 70 may be disposed between the optical distribution means 10-1 and the subscriber device #k_1 and between the optical distribution means 10-2 and the subscriber device #k_2.

Note that, in the configuration of the optical communication system 1a according to the first embodiment illustrated in FIG. 3, it is assumed that a rightward signal (from the subscriber device #k_1 to the subscriber device #k_2) and a leftward signal (from the subscriber device #k_2 to the subscriber device #k_1) flow through a same optical fiber core wire, but the present embodiment is not limited to such a configuration. For example, there may be a section in which the rightward signal and the leftward signal flow through different optical fiber core wires, respectively.

Note that, in the configuration of the optical communication system 1a in the first embodiment illustrated in FIG. 3, a configuration is assumed in which the optical signal carrying the downlink control signal and the optical signal carrying the main signal are multiplexed using a wavelength multiplexer having no wavelength selectivity such as an optical coupler as the optical multiplexing/demultiplexing means 70, but the embodiment is not limited to such a configuration. For example, a wavelength multiplexer having wavelength selectivity such as a wavelength filter may be used as the optical multiplexing/demultiplexing means 70.

Note that, in the configuration of the optical communication system 1a in the first embodiment illustrated in FIG. 3, the optical distribution means 10-1 and the optical distribution means 10-2 are configured using, for example, fiber cross connect (FXC) that outputs light input through each port to another port (a connection relationship is set as a connection port corresponding to the input port) regardless of a wavelength. For example, micro electro mechanical systems (MEMS), a spatial optical switch using a piezo actuator, or the like is used as the optical distribution means 10-1 and the optical distribution means 10-2.

### [Operation of Optical Communication System]

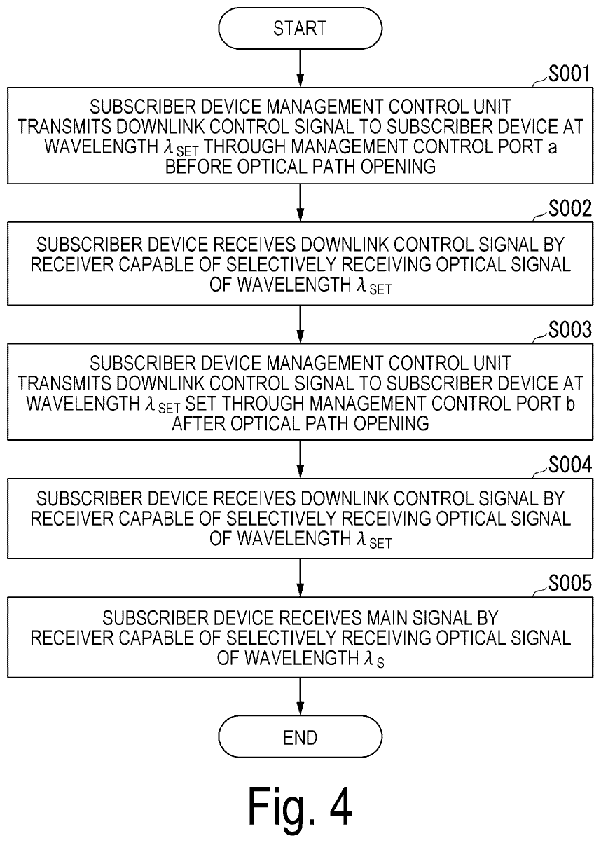

Hereinafter, an example of the operation of the optical communication system 1a will be described. FIG. 4 is a flowchart illustrating an operation of the optical communication system 1a according to the first embodiment of the present invention.

Before the optical path opening between the subscriber device #k_1 and the subscriber device #k_2, the subscriber device management control unit 21 of the control unit 20-2 transmits the downlink control signal to the subscriber device #k_2 at the wavelength λ_{SET} through the management control port a for communication with the subscriber device #k_2 before the optical path opening (step S001). The subscriber device #k_2 receives the downlink control signal by a receiver capable of selectively receiving the optical signal of the wavelength λ_{SET} (step S002).

After the optical path opening between the subscriber device #k_1 and the subscriber device #k_2, the subscriber device management control unit 21 of the control unit 20-2 transmits the downlink control signal to the subscriber device #k_2 at the wavelength λ_{SET} through the management control port b for communication with the subscriber device #k_2 after the optical path opening connected to the optical multiplexing/demultiplexing means 70 that multiplexes the main signal and the downlink control signal (step S003). The subscriber device #k_2 receives the downlink control signal by a receiver capable of selectively receiving the optical signal of the wavelength λ_{SET} (step S004).

In addition, the subscriber device #k_2 receives the main signal by the receiver capable of selectively receiving the optical signal of the wavelength λ_{S} different from the wavelength λ_{SET} (step S005). Thus, the operation of the optical communication system 1a illustrated in the flowchart of FIG. 4 ends.

### Modification 1 of First Embodiment

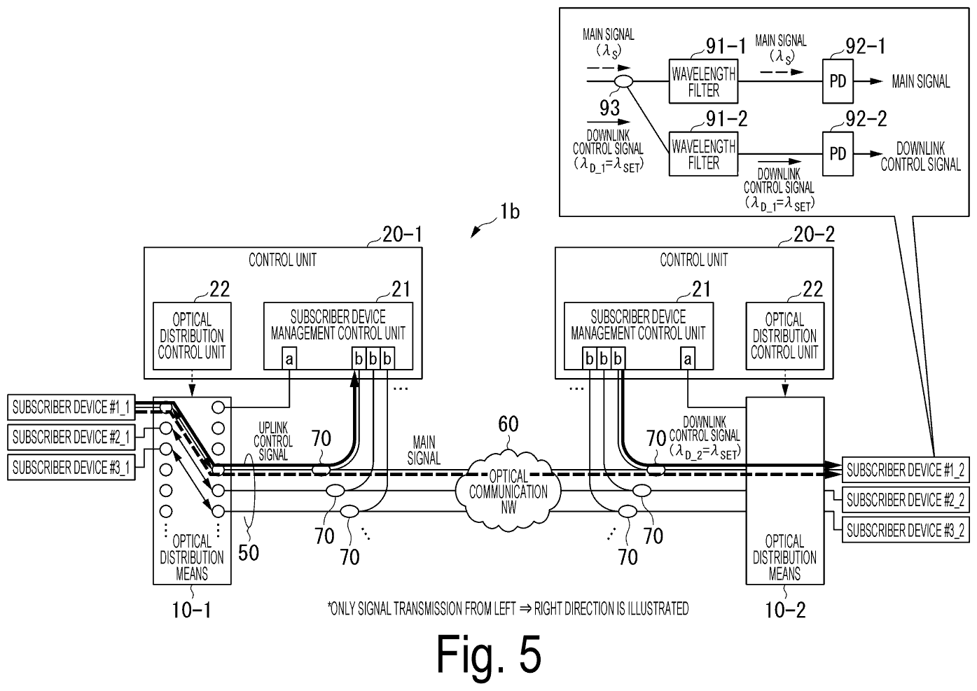

FIG. 5 is an overall configuration diagram of an optical communication system 1b according to a modification 1 of the first embodiment of the present invention.

As illustrated in FIG. 5, the optical communication system 1b in the modification 1 of the first embodiment includes the plurality of subscriber devices #k_1 (k=1, 2, . . . ), the plurality of subscriber devices #k_2 (k=1, 2, . . . ), the optical distribution means 10-1 and the optical distribution means 10-2, the control unit 20-1 and the control unit 20-2, the plurality of optical fiber transmission lines 50, the optical communication network (NW) 60, and the plurality of optical multiplexing/demultiplexing means 70.

Note that, in the following description, among components included in the optical communication system 1b in the modification 1 of the first embodiment illustrated FIG. 5, components having configurations similar to those included in the optical communication system 1a of the first embodiment illustrated in FIG. 3 are denoted by the same reference numerals, and description thereof is omitted.

As illustrated in FIG. 5, unlike the above-described optical communication system 1a of the first embodiment illustrated in FIG. 3, the optical communication system 1b according to the modification 1 of the first embodiment does not include the wavelength multiplexing/demultiplexing means 30-1 and the wavelength multiplexing/demultiplexing means 30-2. Therefore, in the optical communication system 1b in the modification 1 of the first embodiment, the optical signal of the wavelength different from the wavelength of the main signal transmitted from the subscriber device #k_1 reaches the subscriber device #k_2 as the communication partner without being blocked.

In such a configuration, the subscriber device #k_1 transmits the uplink control signal at a wavelength other than the wavelength λ_{D_2}. The wavelength filter 91-2 provided in the preceding stage of the receiver (not illustrated) for downlink control signal reception in the subscriber device #k_2 as the communication partner transmits the downlink control signal having the wavelength λ_{D_2} and blocks the uplink control signal having the wavelength other than the wavelength λ_{D_2}. Therefore, the subscriber device #k_2 as the communication partner can receive the downlink control signal without having the downlink control signal interfere with other signals.

### Modification 2 of First Embodiment

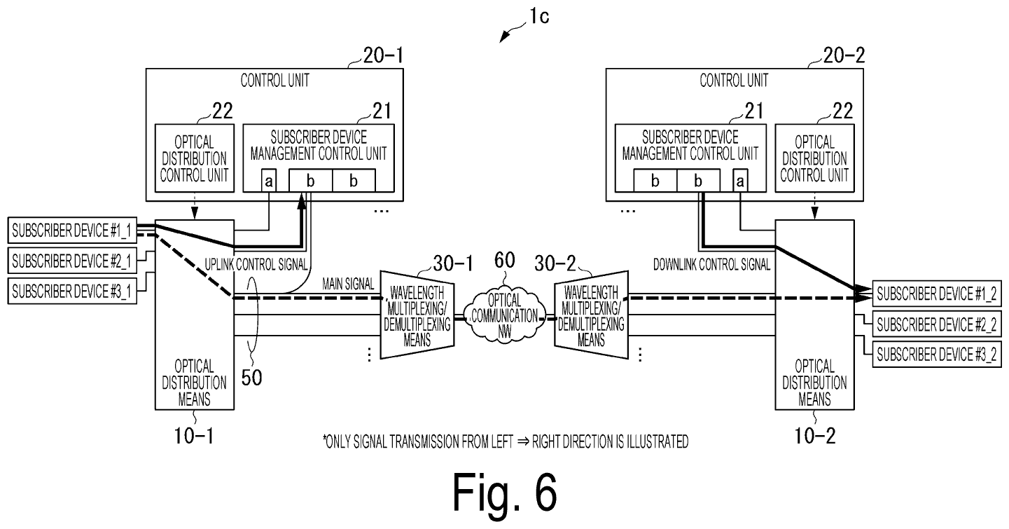

FIG. 6 is an overall configuration diagram of an optical communication system 1c according to a modification 2 of the first embodiment of the present invention.

As illustrated in FIG. 6, the optical communication system 1c in the modification 2 of the first embodiment includes the plurality of subscriber devices #k_1 (k=1, 2, . . . ), the plurality of subscriber devices #k_2 (k=1, 2, . . . ), the optical distribution means 10-1 and the optical distribution means 10-2, the control unit 20-1 and the control unit 20-2, the wavelength multiplexing/demultiplexing means 30-1 and the wavelength multiplexing/demultiplexing means 30-2, the plurality of optical fiber transmission lines 50, and the optical communication network (NW) 60.

Note that, in the following description, among components included in the optical communication system 1c in the modification 2 of the first embodiment illustrated FIG. 6, components having configurations similar to those included in the optical communication system 1a of the first embodiment illustrated in FIG. 3 are denoted by the same reference numerals, and description thereof is omitted.

In the optical communication system 1c according to the modification 2 of the first embodiment, the optical distribution means 10-1 and the optical distribution means 10-2 can set a transmission path for each wavelength. In this case, as illustrated in FIG. 6, the downlink control signal is input through a port different from the port to which the main signal is input, so that the optical signal carrying the main signal and the optical signal carrying the downlink control signal can be multiplexed. For example, arrayed waveguide gratings (AWG), a wavelength selective switch (WSS), or the like is used as the optical distribution means 10-1 and the optical distribution means 10-2.

### Modification 3 of First Embodiment

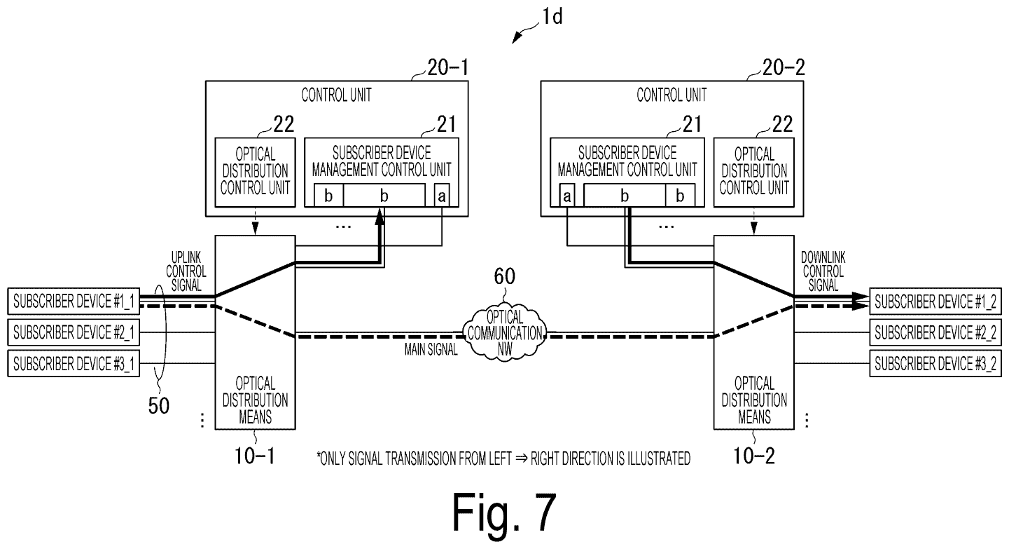

FIG. 7 is an overall configuration diagram of an optical communication system 1d according to a modification 3 of the first embodiment of the present invention.

As illustrated in FIG. 7, the optical communication system 1d in the modification 3 of the first embodiment includes the plurality of subscriber devices #k_1 (k=1, 2, . . . ), the plurality of subscriber devices #k_2 (k=1, 2, . . . ), the optical distribution means 10-1 and the optical distribution means 10-2, the control unit 20-1 and the control unit 20-2, the plurality of optical fiber transmission lines 50, and the optical communication network (NW) 60.

Note that, in the following description, among components included in the optical communication system 1d in the modification 3 of the first embodiment illustrated FIG. 7, components having configurations similar to those included in the optical communication system 1a of the first embodiment illustrated in FIG. 3 are denoted by the same reference numerals, and description thereof is omitted.

The above-described optical communication system 1c according to the modification 2 of the first embodiment illustrated in FIG. 6 has a configuration in which each optical path is wavelength-multiplexed by the wavelength multiplexing/demultiplexing means 30-1 and the wavelength multiplexing/demultiplexing means 30-2 configured using, for example, AWG or WSS. However, since the optical distribution means 10-1 and the optical distribution means 10-2 can wavelength-multiplex each optical path, the wavelength multiplexing/demultiplexing means 30-1 and the wavelength multiplexing/demultiplexing means 30-2 can be omitted as illustrated in FIG. 7.

Note that, in the configuration of the optical communication system 1d according to the modification 3 of the first embodiment illustrated in FIG. 7, a multicast switch (MCS) can also be used as the optical distribution means 10-1 and the optical distribution means 10-2.

### Second Embodiment

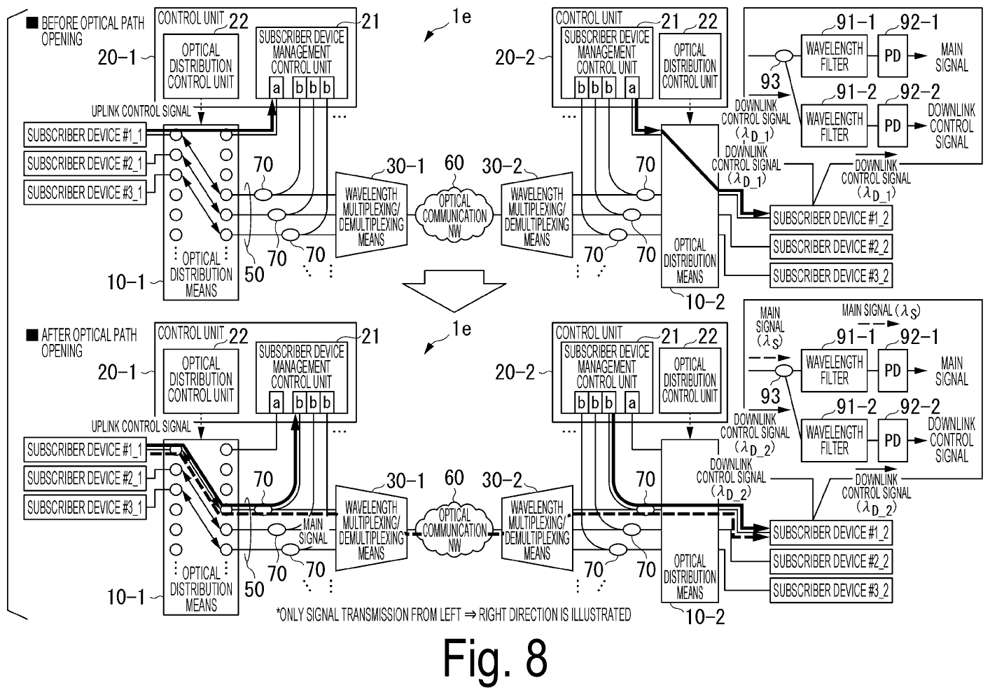

Hereinafter, an optical communication system 1e according to a second embodiment will be described. FIG. 8 is a diagram for describing an optical path opening method in the optical communication system 1e according to the second embodiment of the present invention.

As illustrated in FIG. 8, the optical communication system 1e in the second embodiment includes a plurality of subscriber devices #k_1 (k=1, 2, . . . ), a plurality of subscriber devices #k_2 (k=1, 2, . . . ), an optical distribution means 10-1 and an optical distribution means 10-2, a control unit 20-1 and a control unit 20-2, a wavelength multiplexing/demultiplexing means 30-1 and a wavelength multiplexing/demultiplexing means 30-2, a plurality of optical fiber transmission lines 50, an optical communication network (NW) 60, and a plurality of optical multiplexing/demultiplexing means 70.

Note that, in the following description, among components included in the optical communication system 1e in the second embodiment illustrated FIG. 8, components having configurations similar to those included in the optical communication system 1a of the first embodiment illustrated in FIG. 3 are denoted by the same reference numerals, and description thereof is omitted.

The configuration of the optical communication system 1e according to the second embodiment illustrated in FIG. 8 is different from the configuration of the optical communication system 1a according to the first embodiment illustrated in FIG. 3 in that a wavelength λ_{D_1} of a downlink control signal transmitted through a management control port a for communication with the subscriber device #k_2 before optical path opening and a wavelength λ_{D_2} of a downlink control signal transmitted through a management control port b for communication with the subscriber device #k_2 after optical path opening are not necessarily the same.

Therefore, in the optical communication system 1e according to the second embodiment, the wavelength λ_{D_2} of the downlink control signal to be transmitted through the management control port b for communication with the subscriber device #k_2 after the optical path opening is notified in advance to the subscriber device #k_2 through the management control port a for communication with the subscriber device #k_2 before the optical path opening.

Note that a wavelength λ_{S} of a main signal to be assigned to the subscriber device #k_2 is also notified to the subscriber device #k_2 through the management control port a for communication with the subscriber device #k_2 before the optical path opening. Timing at which the wavelength λ_{S} of the main signal is notified may be the same as or may be different from timing at which the wavelength λ_{D_2} of the downlink control signal is notified.

The subscriber device #k_2 sets a receiver (not illustrated) for downlink control signal reception to selectively receive a signal having the wavelength λ_{D_2}. As illustrated in FIG. 8, the subscriber device k_2 includes a wavelength filter 91-1 in a preceding stage of a receiver (not illustrated) for main signal reception, and a wavelength filter 91-2 in a preceding stage of a receiver for downlink control signal reception. As illustrated in FIG. 8, optical signals demultiplexed by an optical demultiplexing means 93 are input to the wavelength filter 91-1 and the wavelength filter 91-2, respectively. Then, as illustrated in FIG. 8, the subscriber device k_2 is configured to perform direct detection using, for example, a photodiode (PD) 92-1 and a photodiode (PD) 92-2 as photoelectric conversion means.

In the above-described configuration, for example, a wavelength tunable filter is used as the wavelength filter 91-2 provided in the preceding stage of the receiver for downlink control signal reception. In this case, the subscriber device #k_2 sets the wavelength tunable filter (the wavelength filter 91-2) to transmit the signal of the wavelength λ_{D_2}.

Note that, in a case where coherent reception is applied to the reception of the downlink control signal, the subscriber device #k_2 does not need to include the wavelength filter 91-1 and the wavelength filter 91-2. In this case, the subscriber device #k_2 sets the wavelength of local light to be in a vicinity of the notified wavelength λ_{D_2}.

### [Operation of Optical Communication System]

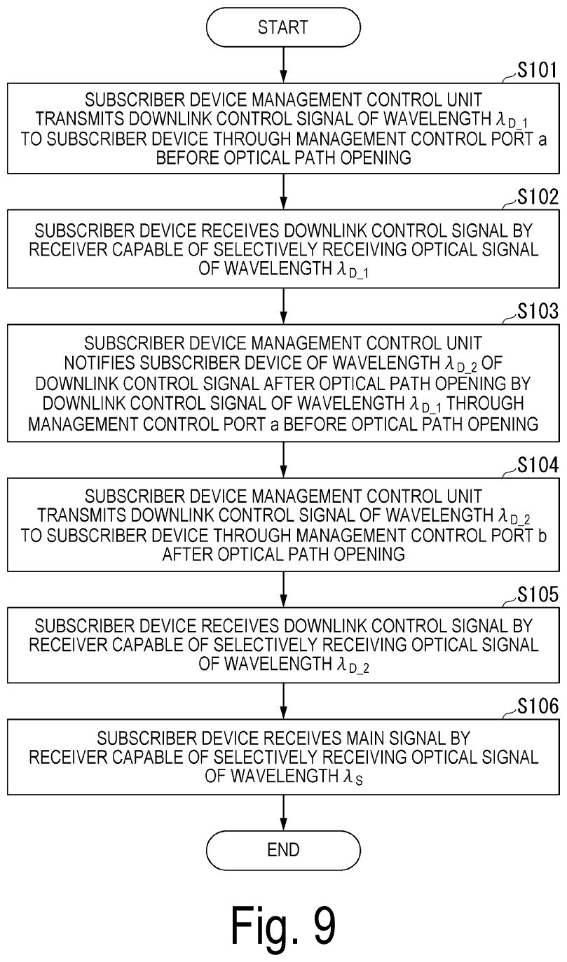

Hereinafter, an example of an operation of the optical communication system 1e will be described. FIG. 9 is a flowchart illustrating an operation of the optical communication system 1e according to the second embodiment of the present invention.

Before the optical path opening between the subscriber device #k_1 and the subscriber device #k_2, a subscriber device management control unit 21 of the control unit 20-2 transmits the downlink control signal to the subscriber device #k_2 at the wavelength λ_{D-1} through the management control port a for communication with the subscriber device #k_2 before the optical path opening (step S101). The subscriber device #k_2 receives the downlink control signal by a receiver capable of selectively receiving the optical signal of the wavelength λ_{D-1} (step S102).

Before the optical path opening between the subscriber device #k_1 and the subscriber device #k_2, the subscriber device management control unit 21 of the control unit 20-2 notifies the wavelength λ_{D_2} of the downlink control signal after the optical path opening to the subscriber device #k_2 using the downlink control signal of the wavelength λ_{D-1} through the management control port a for communication with the subscriber device #k_2 before the optical path opening (step S103).

After the optical path opening between the subscriber device #k_1 and the subscriber device #k_2, the subscriber device management control unit 21 of the control unit 20-2 transmits the downlink control signal to the subscriber device #k_2 at the wavelength λ_{D-2} through the management control port b for communication with the subscriber device #k_2 after the optical path opening connected to the optical multiplexing/demultiplexing means 70 that multiplexes the main signal and the downlink control signal (step S104). The subscriber device #k_2 receives the downlink control signal by a receiver capable of selectively receiving the optical signal of the wavelength λ_{D-2} (step S105).

In addition, the subscriber device #k_2 receives the main signal by a receiver capable of selectively receiving the optical signal of the wavelength λ_{S} different from the wavelengths λ_{D_1} and λ_{D_2} (step S106). Thus, the operation of the optical communication system 1e illustrated in the flowchart of FIG. 9 ends.

### Modification of Second Embodiment

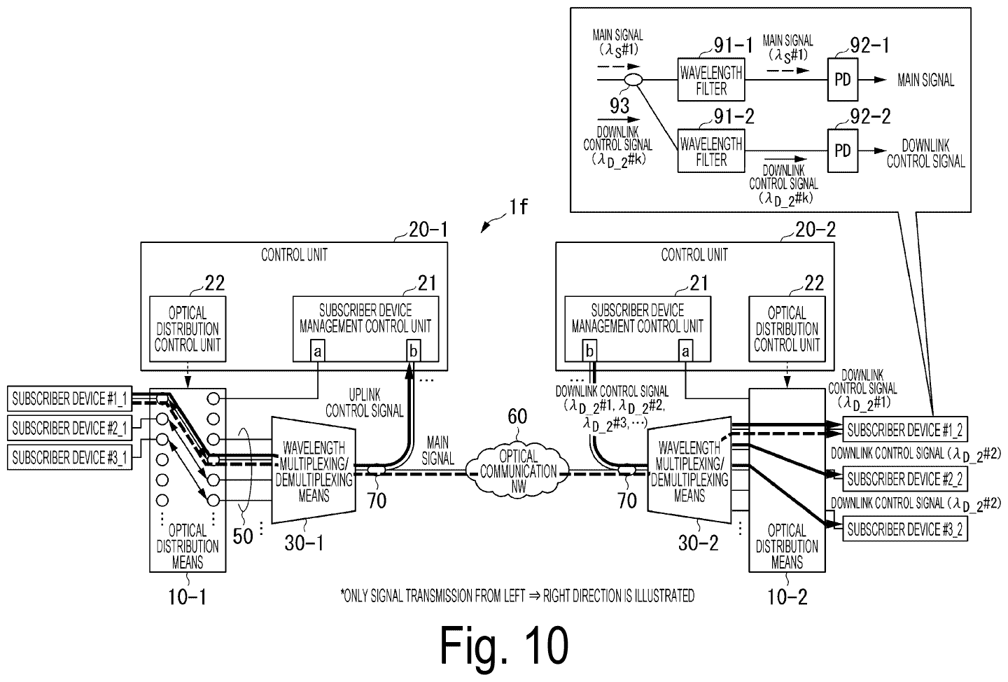

FIG. 10 is an overall configuration diagram of an optical communication system if according to a modification of the second embodiment of the present invention.

As illustrated in FIG. 10, an optical communication system if in the modification in of the second embodiment includes the plurality of subscriber devices #k_1 (k=1, 2, . . . ), the plurality of subscriber devices #k_2 (k=1, 2, . . . ), the optical distribution means 10-1 and the optical distribution means 10-2, the control unit 20-1 and the control unit 20-2, the plurality of optical fiber transmission lines 50, the optical communication network (NW) 60, and the plurality of optical multiplexing/demultiplexing means 70.

Note that, in the following description, among components included in the optical communication system if in the modification of the second embodiment illustrated FIG. 10, components having configurations similar to those included in the optical communication system 1a of the first embodiment illustrated in FIG. 3 are denoted by the same reference numerals, and description thereof is omitted.

In the optical communication system if according to the modification of the second embodiment, the management control port b for communication with the subscriber device #k_2 after the optical path opening switches the wavelength of the optical signal output through the management control port b according to a destination of the downlink control signal. Here, in a case where the wavelength allocated to the optical path connecting the subscriber device #k_1 and the subscriber device #k_2 is λ_{S}#k, and a free spectral range (FSR) of the wavelength multiplexing/demultiplexing means 30-1 and the wavelength multiplexing/demultiplexing means 30-2 is Δλ_{FSR}, the management control port b sets a wavelength λ_{D_2}#k of the downlink control signal to the subscriber device #k_1 and the subscriber device #k_2 as in the following equation (1).

$${λ}_{D \_ 2} \# k = {λ}_{S} \# k \pm Δ {λ}_{FSR} \times h ( h = 1 , 2 , 3 , … ) \qquad ( 1 )$$

With such a configuration, the number of management control ports b can be reduced.

The subscriber device #k_1 and the subscriber device #k_2 recognize the wavelength λ_{D_2}#k of the downlink control signal transmitted through the management control port b for communication with the subscriber device after the optical path opening to its own devices by the notification transmitted in advance through the management control port a for communication with the subscriber device before the optical path opening.

The wavelength λ_{S}#k of the main signal and the wavelength λ_{D_2}#k of the downlink control signal may be notified to the subscriber device #k_1 and the subscriber device #k_2 in advance through the management control port a for communication with the subscriber device before the optical path opening.

Alternatively, only the wavelength λ_{S}#k of the main signal may be notified to the subscriber device #k_1 and the subscriber device #k_2 in advance through the management control port a for communication with the subscriber device before the optical path opening. In the case where only the wavelength λ_{S}#k of the main signal is notified in advance, the subscriber device #k_1 and the subscriber device #k_2 may set the receiver (not illustrated) for receiving the downlink control signal so as to selectively receive the optical signal of the wavelength λ_{D_2}#k that satisfies the above equation (1).

As described above, the optical communication system in each of the above-described embodiments and modifications of the embodiments includes the optical multiplexing/demultiplexing means 70 on the optical fiber transmission line 50, and includes the management control port for communication with the subscriber device before and after optical path opening in the subscriber device management control unit 21. Then, the above-described optical communication system includes the optical demultiplexing means 93, the wavelength filter 91-1, and the wavelength filter 91-2 at the preceding stage of the receiver (not illustrated) for main signal reception and the receiver (not illustrated) for downlink control signal reception provided in the subscriber device.

With such a configuration, according to the optical communication system in each of the embodiments and the modifications of the embodiments, the subscriber device including the receiver (not illustrated) having reception wavelength selectivity in reception of the downlink control signal can receive the downlink control signal transmitted from the subscriber device management control unit 21 before the optical path opening. As a result, it is possible to exchange the control signal between the subscriber device and the management control port a of the subscriber device management control unit 21 before the optical path opening, and it is possible to open the optical path between the subscriber devices.

Further, with such a configuration, according to the optical communication system in each of the embodiments and the modifications of the embodiments, the subscriber device including the receiver (not illustrated) having reception wavelength selectivity in reception of the downlink control signal can receive the downlink control signal transmitted from the subscriber device management control unit 21 without interfering with other signals after the optical path opening. As a result, after the optical path opening, it is possible to exchange the control signal between the subscriber device and the management control port b of the subscriber device management control unit 21, and the subscriber device management control unit 21 can monitor the states of the optical path and the subscriber device and control switching of the optical path.

According to the above-described embodiments, a communication device(apparatus) is a first communication device in an optical communication system including the first communication device, a second communication device, and a control device that controls opening of an optical path between the first communication device and the second communication device. For example, the first communication device is the subscriber device #k_2 in the embodiments, the second communication device is the subscriber device #k_1 in the embodiments, the control device is the control unit 20-2 in the embodiments, and the optical communication system is one of the optical communication systems 1a to if in the embodiments.

The above communication device(apparatus) includes a first reception unit and a second reception unit. The first reception unit receives a downlink control signal that is an optical signal having a predetermined wavelength transmitted from the control device. The second reception unit receives a main signal that is an optical signal having a wavelength different from the predetermined wavelength transmitted from the second communication device. For example, the first reception unit is the photodiode (PD) 92-2 in the embodiments, and the second reception unit is the photodiode (PD) 92-1 in the embodiments. Furthermore, for example, the predetermined wavelength is the wavelength λ_{SET}, the wavelength λ_{D_1}, or the wavelength λ_{D_2} in the embodiments, and the wavelength different from the predetermined wavelength is the wavelength λ_{S} in the embodiments.

Note that, in the above communication device(apparatus), the downlink control signal may be an optical signal transmitted through a first communication port of the control device before the opening of the optical path, and may be an optical signal demultiplexed from an optical signal transmitted through a second communication port of the control device, the second communication port being different from the first communication port, multiplexed with the main signal and transmitted, after the opening of the optical path. For example, the first communication port is the management control port a in the embodiments, and the second communication port is the management control port b in the embodiments.

Note that the above communication device(apparatus) may further include a first wavelength filter and a second wavelength filter. For example, the first wavelength filter is the wavelength filter 91-2 in the embodiments, and the second wavelength filter is the wavelength filter 91-1 in the embodiments. The first wavelength filter is provided in the preceding stage of the first reception unit, and can selectively receive the optical signal of a predetermined wavelength. The second wavelength filter is provided in the preceding stage of the second reception unit, and can selectively receive the optical signal of a wavelength different from the predetermined wavelength.

Note that the above communication device(apparatus) may further include an optical demultiplexer. For example, the optical demultiplexer is the optical demultiplexing means 93 in the embodiments. The optical demultiplexer demultiplexes an optical signal obtained by multiplexing the main signal transmitted from the second communication device and the downlink control signal transmitted from the control device, and distributes the optical signal to the first wavelength filter and the second wavelength filter.

Note that, in the above communication device(apparatus), the first reception unit may receive, before the opening of the optical path, the downlink control signal transmitted from the control device, the downlink control signal including wavelength switching information indicating the wavelength of the downlink control signal to be received after the opening of the optical path, and may perform a setting change to receive the downlink control signal of the wavelength based on the wavelength switching information after the opening of the optical path. For example, the wavelength of the downlink control signal to be received after the optical path opening is the wavelength λ_{D_2} in the embodiments.

Note that, in the above communication device(apparatus), the wavelength included in the wavelength switching information may be a wavelength allocated to each of a plurality of the first communication devices so as to be different from each other.

Note that, in the above communication device(apparatus), the wavelength allocated to each of the plurality of first communication devices so as to be different from each other may be a wavelength allocated so that a frequency difference from the wavelength of the main signal received by the first communication device is an integral multiple of a resonance frequency interval (FSR) in a wavelength multiplexing/demultiplexing means provided in a communication path between the first communication device and the second communication device. For example, the resonance frequency interval in the wavelength multiplexing/demultiplexing means is FSR(Δλ_{FSR}) of the wavelength multiplexing/demultiplexing means 30-1 and the wavelength multiplexing/demultiplexing means 30-2 in the embodiments.

Note that the above communication device(apparatus) may further include a first transmission unit and a second transmission unit. For example, the first transmission unit is a transmitter (not illustrated) that transmits the main signal from the subscriber device #k_2 to the subscriber device #k_2 in the embodiments, and the second transmission unit is a transmitter (not illustrated) that transmits the uplink control signal from the subscriber device #k_2 to the control unit 20-2 in the embodiments. The first transmission unit transmits the main signal to the second communication device. The second transmission unit transmits the uplink control signal to the control device at a wavelength different from the wavelength used for transmission of the main signal, or transmits the uplink control signal by multiplexing the frequency on the same wavelength as the wavelength used for transmission of the main signal.

Furthermore, according to the above-described embodiments, the optical communication system includes the first communication device, the second communication device, and the control device that controls opening of an optical path between the first communication device and the second communication device. For example, the optical communication system is one of the optical communication systems 1a to if in the embodiments, the first communication device is the subscriber device #k_2 in the embodiments, the second communication device is the subscriber device #k 1 in the embodiments, the control device is the control unit 20-2 in the embodiments.

The above control device transmits the downlink control signal through the first communication port to the first communication device at a predetermined wavelength before the opening of the optical path. In addition, the control device transmits the downlink control signal to the first communication device at a predetermined wavelength through the second port connected to an optical multiplexing means that multiplexes the main signal and the downlink control signal after the opening of the optical path. For example, the first communication port is the management control port a in the embodiments, the predetermined wavelength is the wavelength λ_{SET}, the wavelength λ_{D_1}, or the wavelength λ_{D_2} in the embodiments, the second communication port is the management control port b in the embodiments, and the optical multiplexing means is the optical multiplexing/demultiplexing means 70 in the embodiments.

The above first communication device receives the downlink control signal by a first reception means capable of receiving the optical signal of the predetermined wavelength. In addition, the above first communication device receives the main signal by a second reception means capable of receiving the optical signal of the wavelength different from the predetermined wavelength. For example, the first reception means is the photodiode (PD) 92-2 in the embodiments, the wavelength different from the predetermined wavelength is the wavelength λ_{S} in the embodiments, and the second reception means is the photodiode (PD) 92-1 in the embodiments.

Note that the above control device may transmit the downlink control signal including the wavelength switching information indicating the wavelength of the downlink control signal to be received after the opening of the optical path to the first communication device before opening of the optical path. For example, the wavelength of the downlink control signal to be received after the optical path opening is the wavelength λ_{D_2} in the embodiments.

A part of the configurations of the optical communication systems 1a to if in the above-described embodiments may be implemented by a computer. In that case, a program for implementing the functions may be recorded in a computer-readable recording medium, and the functions may be implemented by loading the program recorded in this recording medium to a computer system, and executing the program. The “computer system” herein includes an OS and hardware such as a peripheral device. In addition, the “computer-readable recording medium” refers to a portable medium such as a flexible disk, a magneto-optical disk, a ROM, or a CD-ROM, or a storage device such as a hard disk built in a computer system. Further, the “computer-readable recording medium” may include a medium that dynamically holds the program for a short time, such as a communication line in a case where the program is transmitted via a network such as the Internet or a communication line such as a telephone line, and a medium that holds the program for a certain period of time, such as a volatile memory inside a computer system serving as a server or a client in that case. In addition, the program described above may be for implementing some of the functions described above, may be implemented in a combination of the functions described above and a program already recorded in a computer system, or may be implemented with a programmable logic device such as a field programmable gate array (FPGA).

Although the embodiments of the present invention have been described in detail with reference to the drawings, the specific configuration is not limited to the embodiments, and includes design and the like within the scope not departing from the gist of the present invention.

### REFERENCE SIGNS LIST

1, 1′, 1a to if Optical communication system
10-1, 10-2 Optical distribution means
20-1, 20-2 Control unit
21 Subscriber device management control unit
22 Optical distribution control unit
30-1, 30-2 Wavelength multiplexing/demultiplexing means
50 Optical fiber transmission line
60 Optical communication network (NW)
70 Optical multiplexing/demultiplexing means
91-1, 91-2 Wavelength filter
92-1, 92-2 Photodiode (PD)
93 Optical demultiplexing means

1. A communication device that is a first communication device in an optical communication system including the first communication device, a second communication device, and a control device that controls opening of an optical path between the first communication device and the second communication device, the communication device comprising:
a first receiver configured to receive a downlink control signal that is an optical signal having a predetermined wavelength transmitted from the control device; and
a second receiver configured to receive a main signal that is an optical signal having a wavelength different from the predetermined wavelength transmitted from the second communication device.

2. The communication device according to claim 1, wherein
the downlink control signal is an optical signal transmitted through a first communication port of the control device before the opening of the optical path, and is an optical signal demultiplexed from an optical signal transmitted through a second communication port of the control device, the second communication port being different from the first communication port, multiplexed with the main signal and transmitted, after the opening of the optical path.

3. The communication device according to claim 1, further comprising:
a first wavelength filter provided in a preceding stage of the first receiver and capable of selectively receiving the optical signal having the predetermined wavelength; and
a second wavelength filter provided in a preceding stage of the second receiver and capable of selectively receiving the optical signal having a wavelength different from the predetermined wavelength.

4. The communication device according to claim 3, further comprising:
an optical demultiplexer configured to demultiplex an optical signal obtained by multiplexing the main signal transmitted from the second communication device and the downlink control signal transmitted from the control device, and distribute the optical signal to the first wavelength filter and the second wavelength filter.

5. The communication device according to claim 1, wherein
the first receiver receives, before the opening of the optical path, the downlink control signal transmitted from the control device, the downlink control signal including wavelength switching information indicating the wavelength of the downlink control signal to be received after the opening of the optical path, and
performs a setting change to receive the downlink control signal of the wavelength based on the wavelength switching information after the opening of the optical path.

6. The communication device according to claim 5, wherein
the wavelength included in the wavelength switching information is a wavelength allocated to each of a plurality of the first communication devices so as to be different from each other.

7. An optical path opening method in an optical communication system including a first communication device, a second communication device, and a control device that controls opening of an optical path between the first communication device and the second communication device, the optical path opening method comprising:
transmitting, by the control device, a downlink control signal to the first communication device at a predetermined wavelength through a first communication port before opening of the optical path;
transmitting, by the control device, the downlink control signal to the first communication device at a predetermined wavelength through a second port connected to an optical multiplexing means that multiplexes a main signal and the downlink control signal, after the opening of the optical path;
receiving, by the first communication device, the downlink control signal by a first reception means capable of receiving an optical signal of the predetermined wavelength; and
receiving, by the first communication device, the main signal by a second reception means capable of receiving an optical signal of a wavelength different from the predetermined wavelength.

8. The optical path opening method according to claim 7, further comprising:
transmitting, by the control device, before the opening of the optical path, the downlink control signal to the first communication device, the downlink control signal including wavelength switching information indicating a wavelength of the downlink control signal to be received after the opening of the optical path.
